(19) United States
(12) Patent Application Publication
(10) Pub. No.: US 2015/0316374 A1
(43) Pub. Date: Nov. 5, 2015

(54) MEASUREMENT SYSTEM HAVING ACTIVE TARGET OBJECTS

(71) Applicant: HILTI AKTIENGESELLSCHAFT, Schaan (LI)

(72) Inventor: Andreas Winter, Feldkirch (AT)

(73) Assignee: HILTI AKTIENGESELLSCHAFT, Schaan (LI)

(21) Appl. No.: 14/646,996

(22) PCT Filed: Nov. 26, 2013
(86) PCT No.: PCT/EP2013/074718

§ 371 Date: May 22, 2015

(30) Foreign Application Priority Data
Nov. 28, 2012 (DE) 10 2012 221 767.3

(51) Int. Cl. G01C 15/00

(52) U.S. Cl. CPC G01C 15/002

(57) ABSTRACT

A measuring system (10), including a laser measuring device (11) emitting a search beam (17) and a measurement beam (18), a first active target object (12) having a first transmitting device for emitting a first visible transmission beam and a second active target object (13) having a second transmitting device for emitting a second visible transmission beam, wherein the color of light of the second visible transmission beam differs from the color of light of the first visible transmission beam.

The present invention is directed to a surveying system including active target objects.

Laser measuring devices are used for measuring target points which determine the distances and directions (angles) of the target points. Laser measuring devices are known which are designed as a theodolite, a total station, a dumpy level, or a laser scanner. The laser measuring devices include a distance measuring device for measuring the distance between the target point and the distance measuring device and an angle measuring device for measuring angles. The measurement of the target points is supported by target objects which are placed at the target points. The target objects are used in surveying systems including laser measuring devices which transmit a search beam and a measuring beam, the wavelengths for the search beam and the measuring beam being advantageously different. The measuring beam is used for the measuring task of the laser measuring device, e.g., for measuring the distance and/or the angle, and the search beam is used to find and identify the target objects. Due to the different tasks of the search beam and the measuring beam, the search beam is strongly expanded for the purpose of detecting a larger spatial area, whereas a focused measuring beam is used for the measuring task. The target objects are subdivided into passive target objects which reflect the search beam of the laser measuring device and active target objects which do not reflect the search beam, but transmit a transmission beam. Active target objects have the advantage that the laser measuring device is able to distinguish the transmission beam, due to a different wavelength, from the beams which are reflected from the reflective surfaces.

EP 1 734 336 A1 provides an active target object for a laser measuring device which transmits an infrared search beam and a measuring beam. The target object includes a reflector including at least one reflecting element for reflecting the measuring beam, a receiver including a receiving element for receiving the infrared search beam, a transmitter including a transmitting element for transmitting a visible or an infrared search beam and a control device including an evaluation element for evaluating the received search beam and a control element for controlling the transceiver devices. The target objects have the disadvantage that it is not possible to identify and to differentiate between the target objects. The visible or infrared transmission beams have the same wavelength for several target objects in a surveying system.

### SUMMARY OF THE INVENTION

It is an object of the present invention to provide a surveying system composed of a laser measuring device and multiple active target objects, the target objects being unambiguously identifiable for the laser measuring device and also being distinguishable from other objects for the user. Moreover, the equipment expenditures in the laser measuring device for identifying the target object should be preferably low.

The present invention provides a surveying system that includes:
a laser measuring device, which transmits a search beam and a measuring beam,
a first active target object including a reflector for reflecting the measuring beam, a first receiver for receiving the search beam, a first transmitter for transmitting a first visible transmission beam, and a first control device for evaluating the received search beam and for controlling the transceiver devices, and
a second active target object including a second reflector for reflecting the measuring beam, a second receiver for receiving the search beam, a second transmitter for transmitting a second visible transmission beam, and a second control device for evaluating the received search beam and for controlling the transceiver devices, the light color of the second visible transmission beam being different from the light color of the first visible transmission beam.

To carry out the identification of a target object with the aid of a visible transmission beam has the advantage that undesirable reflections of the search beam, which is frequently implemented as an infrared laser beam, from reflective surfaces, such as mirror surfaces, safety vests, traffic signs, and license plates, are not detected. The colored visible transmission beam is detected by a camera unit; the target object may be identified in the differential image of the camera unit. Moreover, differently colored visible transmission beams may also be distinguished from one another by the user of a surveying system.

The term “visible transmission beam” is a summary of the following: a single visible laser beam, multiple visible laser beams which are transmitted at the same time, but are spatially spaced apart from one another, and multiple visible laser beams which are transmitted consecutively. In the case of multiple laser beams, the visible transmission beam is composed of multiple partial beams which are spatially spaced apart from one another or which are transmitted consecutively.

The surveying system preferably includes at least one further active target object including a reflector, a receiver, a transmitter for transmitting a further visible transmission beam, and a control device, the light color of the at least one further visible transmission beam being different from the light color of the first and the second visible transmission beams.

The light colors of the visible transmission beams and/or of the visible partial beams are preferably selected from the light colors red, orange, yellow, green, blue, and violet. The six light colors red, orange, yellow, green, blue, and violet are reliably distinguishable from one another for the laser measuring device and for the user. The wavelengths of the visible spectrum range are between approximately 380 nm and 750 nm. In the visible spectrum, it is differentiated between six different light colors: violet (380 nm through 420 nm), blue (420 nm through 490 nm), green (490 nm through 575 nm), yellow (575 nm through 585 nm), orange (585 nm through 650 nm), and red (650 nm through 750 nm).

The light colors of the visible transmission beams and/or of the visible partial beams are preferably selected from the light colors red, green, and blue. The light colors red, green, and blue are particularly suitable for the visible transmission beams, since red, green, and blue light-emitting diodes are cost-effectively commercially available.

### BRIEF DESCRIPTION OF THE DRAWINGS

Exemplary embodiments of the present invention are described in the following with reference to the drawing. The latter is not necessarily supposed to represent the exemplary embodiments true to scale, but the drawing is rather implemented schematically and/or in a slightly distorted form, where it is helpful to the explanation. With regard to the additions of the teachings which are directly apparent from the drawing, reference is made to the pertinent prior art. In this case, it must be noted that various modifications and changes with regard to the form and the detail of a specific embodiment may be carried out without departing from the general idea of the present invention. The features of the present invention described in the description, the drawing as well as the claims may be essential to refining the present invention, both individually and in any arbitrary combination. All combinations of at least two of the features which are described in the description, the drawing and/or the claims are within the scope of the present invention. The general idea of the present invention is not limited to the exact form or detail of the preferred specific embodiment which is shown and described in the following or limited to an object which would be limited in comparison to the object which is claimed in the claims. In the case of the provided measurement ranges, values which are within the mentioned limits are also supposed to be provided as limiting values and be arbitrarily usable and claimable. For the sake of simplicity, the same reference numerals are used in the following for identical or similar parts or parts having an identical or a similar function.

FIG. 1 shows a surveying system according to the present invention including a laser measuring device, a first active target object and a second active target object;

FIG. 2 shows the design of the active target objects in detail.

### DETAILED DESCRIPTION

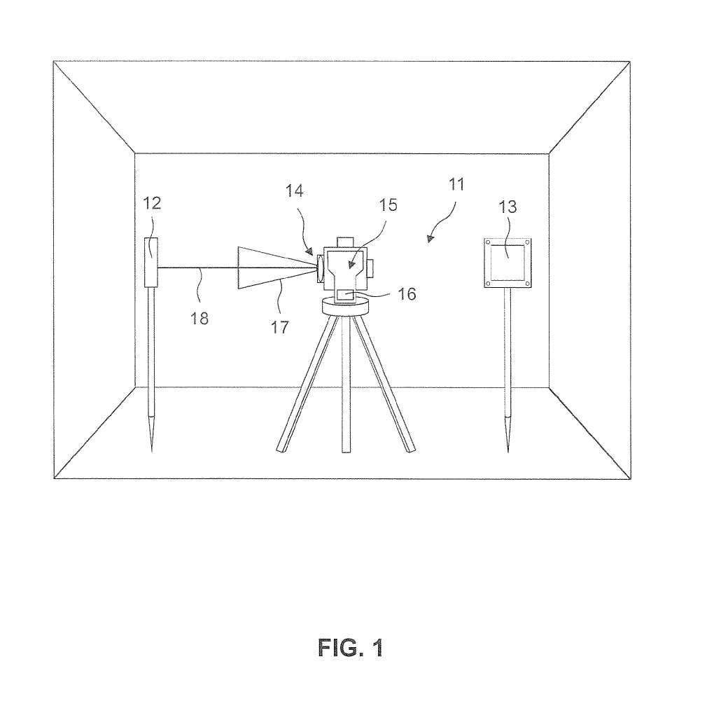

FIG. 1 shows a surveying system 10 according to the present invention which is composed of a laser measuring device 11, a first active target object 12 and a second active target object 13 in a schematic representation. In the exemplary embodiment of FIG. 1, target objects 12, 13 are fastened on a telescopic pole or a level rod and which are situated on the floor of a room. In addition to being fastened on a telescopic pole or a level rod, the target objects may be fastened on a wall or a ceiling.

Laser measuring device 11 includes a laser measuring unit 14, a camera unit 15 and a control device 16. Laser measuring unit 14 includes a first and a second beam source, the first beam source transmitting a search beam 17 and the second beam source transmitting a measuring beam 18. Search beam 17 is used to recognize and identify target objects in the measurement environment. In order for search beam 17 not to disturb the users and other people in the measurement environment, the search beam is frequently implemented as an infrared search beam, other wavelengths also being suitable for search beam 17. Measuring beam 18 is used for the measuring task of laser measuring device 11, e.g., for measuring the laser distance and/or for measuring the angles; measuring beam 18 is not used in the case of the method for identifying target objects 12, 13. Due to the different tasks of search beam 17 and measuring beam 18, search beam 17 may be strongly expanded for the purpose of detecting a larger spatial area, whereas a focused measuring beam 18 is used for the measuring task.

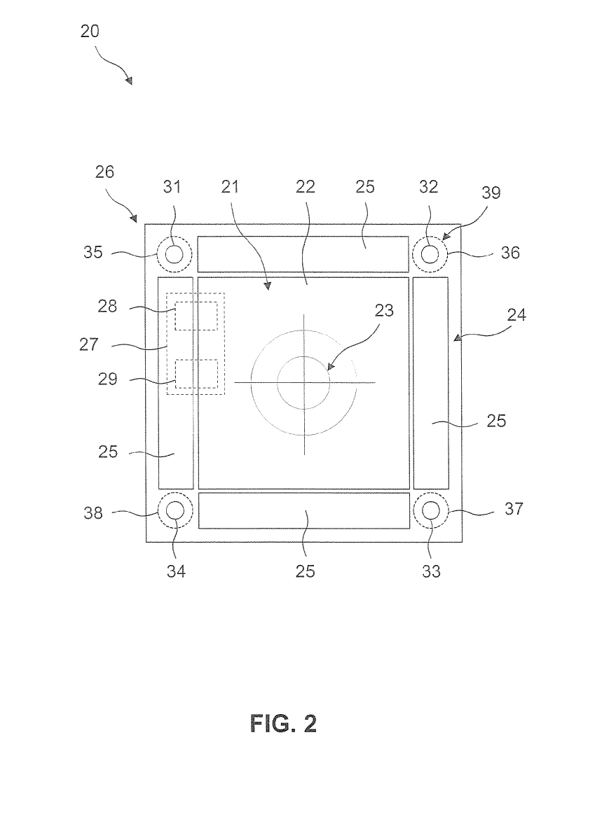

FIG. 2A shows the design of an active target object 20 for surveying system 10 according to the present invention of FIG. 1. Target object 20 may be used in surveying system 10 of FIG. 1 as a first or as a second target object 12, 13. In order to distinguish the components of first and second target objects 12, 13 as well as further target objects of surveying system 10 an index “i” is used.

Target object 20 includes a reflector 21 including a reflecting element 22 for reflecting measuring beam 18 and a target element 23 for orienting measuring beam 18, a receiver 24 including four receiving elements 25 for receiving search beam 17, a transmitter 26 for transmitting a visible transmission beam, and a control device 27. Control device 27 includes an evaluation element 28 for evaluating received search beam 17 and a control element 29 for controlling transceiver devices 24, 26.

Transmitter 26 includes four monochrome beam sources 31, 32, 33, 34, which may be implemented in the light colors red, green, and blue. Beam sources 31, 32, 33, 34 are situated in the four corners of rectangular target object 20. First beam source 31 transmits a first visible partial beam 35, second beam source 32 transmits a second visible partial beam 36, third beam source 33 transmits a third visible partial beam 37, and fourth beam source 34 transmits a fourth visible partial beam 38. Each target object transmits an unambiguous visible transmission beam 39 which is composed of four visible partial beams 35, 36, 37, 38, not every one of the four partial beams 35, 36, 37, 38 being necessarily switched on. With the aid of the four beam sources 31, 32, 33, 34, it is possible to identify and distinguish from one another 3⁴=81 target objects. The following applies to the number of the target objects in the case of the same beam sources: The number of the colors of a beam source raised to a higher power by the number of the beam sources.

1-4. (canceled)

5. A surveying system comprising:
a laser measurer transmitting a search beam and a measuring beam;
a first active target object including a first reflector for reflecting the measuring beam, a first receiver for receiving the search beam, a first transmitter for transmitting a first visible transmission beam, and a first controller for evaluating the received search beam and for controlling the first receiver and first transmitter, and
a second active target object including a second reflector for reflecting the measuring beam, a second receiver for receiving the search beam, a second transmitter for transmitting a second visible transmission beam, and a second controller for evaluating the received search beam and for controlling the second receiver and second transmitter, a second light color of the second visible transmission beam being different from a first light color of the first visible transmission beam.

6. The surveying system as recited in claim 5 further comprising at least one further active target object including a reflector, a receiver, a transmitter for transmitting a further visible transmission beam, and a controller, a further light color of the at least one further visible transmission beam being different from the first and second light colors.

7. The surveying system as recited in claim 5 wherein the first and second light colors are selected from the colors red, orange, yellow, green, blue, and violet.

8. The surveying system as recited in claim 7 wherein the first and second light colors are selected from the colors red, green, and blue.
